(19) United States
(12) Patent Application Publication
(10) Pub. No.: US 2017/0367423 A1
(43) Pub. Date: Dec. 28, 2017

(54) HEADBAND FOR VIRTUAL REALITY GOGGLES

(71) Applicant: Six Flags Theme Parks, Inc., Grand Prairie, TX (US)

(72) Inventors: Michael Reitz, Philadelphia, PA (US); Glenn Kolinek, San Antonio, TX (US); John Durbin, Jenkintown, PA (US); Matteo Ferrari, Mountain Lakes, NJ (US)

(21) Appl. No.: 15/626,946

(22) Filed: Jun. 19, 2017

Related U.S. Application Data
(60) Provisional application No. 62/353,678, filed on Jun. 23, 2016.
(60) Provisional application No. 62/381,133, filed on Aug. 30, 2016.

(51) Int. Cl. A42B 1/22; G02C 3/02; A42B 1/04; A42B 1/24

(52) U.S. Cl. CPC A42B 1/22; G02C 3/02; A42B 1/045; A42B 1/245

(57) ABSTRACT

A headband for VR goggles includes an adjustment mechanism to accommodate a wide variety of users, padding to ensure user comfort, a pivotable goggle holding element to allow the goggles to pivot relative to the user's head and a chin strap fastener to secure the headband to the user's head.

### CROSS-REFERENCE TO RELATED APPLICATIONS

The present application claims benefit of and priority to Provisional Patent Application Ser. No. 62/353,678 entitled HEADBAND FOR VIRTUAL REALITY GOGGLES filed Jun. 23, 2016 and Provisional Patent Application Ser. No. 62/381,133 entitled HEADBAND FOR VIRTUAL REALITY GOGGLES filed Aug. 30, 2016, the entire contents of each of which are incorporated by reference herein.

### BACKGROUND

### Field of the Invention

The present invention relates generally to a headband for use in supporting virtual reality goggles on the head of a user.

### Related Art

Virtual reality (VR) experiences are becoming more and more popular. A key feature of VR is the VR goggles that are used to immerse the user visually into a virtual world. In order to maintain this presence in the virtual world, it is important that the VR goggles remain in place on the user's head and properly aligned with the user's eyes while at the same time fit comfortably such that they are not a distraction to the user. A secure fit is important to secure the VR goggles as the user moves around, or as the user is moved by conveyance.

Accordingly, it would be desirable to provide a headband for safely and comfortably securing VR goggles to a user's head.

### SUMMARY

It is an object of the present invention to provide a headband for securing VR goggles to a user's head in a secure and comfortable manner. The headband is preferably adjustable in size to accommodate a wide variety of users with different head sizes. In addition, the headband preferably includes cushioning or padding to provide for comfort. In addition, at least one pivot point is preferably provided such that the goggles can be pivoted up and away from the user's eyes while the headband remains on the user's head. Finally, the headband preferably also includes an adjustable, locking chin strap to secure the headband to the user's head.

A headband in accordance with an embodiment of the present disclosure includes a rear element extending from one side of a user's head to the opposite side thereof, a top element extending from one side of the rear element to the opposite side of the rear element and extending over a top of the user's head, an adjustment element connected to the rear element such that manipulation of the adjustment element adjusts a length of the rear element and a goggle fastening device pivotally connected to the rear element and connectable to the VR goggles such that the VR goggles are pivotable relative to the rear element.

A headband in accordance with an embodiment of the present disclosure includes a rear element extending from one side of a user's head to the opposite side thereof, a top element extending over a top of the user's head from one side of the rear element to the opposite side of the rear element, an adjustment element connected to the rear element such that manipulation of the adjustment element adjusts a length of the rear element and a goggle fastening device connected to the rear element and connectable to the VR goggles.

Other features and advantages of the present invention will become apparent from the following description of the invention which refers to the accompanying drawings.

### BRIEF DESCRIPTION OF THE DRAWINGS

The present invention is described in greater detail below, with reference to the accompanying drawings, in which:

FIG. 1 illustrates a side view of a headband in accordance with an embodiment of the present invention on a user's head;

FIG. 2 illustrates a rear and side perspective view of the headband of FIG. 1;

FIG. 3 illustrates a front and side perspective view of the headband of FIG. 1;

FIG. 4 illustrates another front and side perspective view of the headband of FIG. 1;

FIG. 5 illustrates a side view of the headband of FIG. 1 with the VR goggles attached thereto pivoted up and above the user's eyes;

FIG. 6 front and side perspective view the headband of FIG. 1 on a user with a chin strap in a loose or open position;

FIG. 7 front and side perspective view the headband of FIG. 1 with a chin strap in a locked position under the user's chin to hold the headband in place;

FIG. 8 illustrates a side view of a headband in accordance with another embodiment of the present invention on a user's head;

FIG. 9 is a more detailed view of a fastening portion of the headband of FIG. 8.

FIG. 10 is a more detailed view of an attachment bracket suitable for use with the fastening portion of the headband of the FIG. 8.

### DETAILED DESCRIPTION OF THE EMBODIMENTS

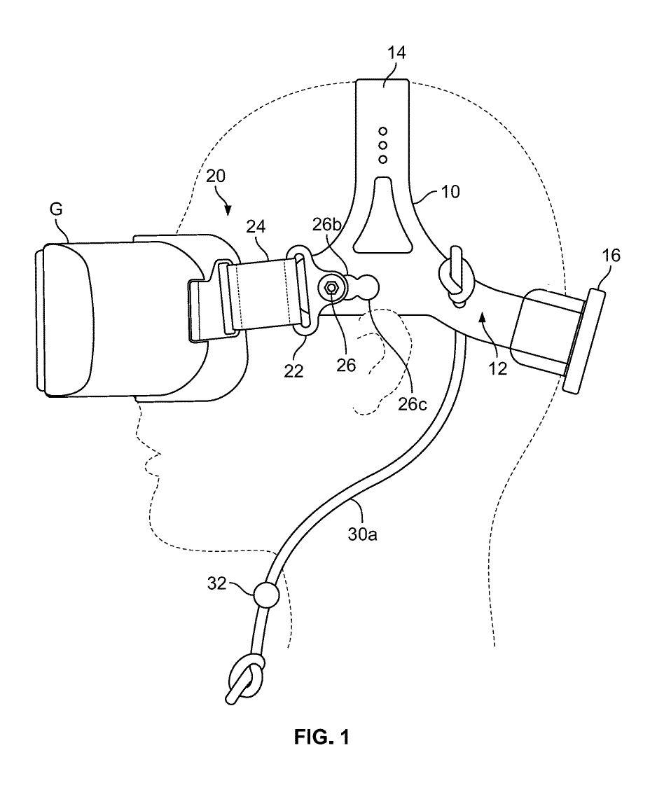

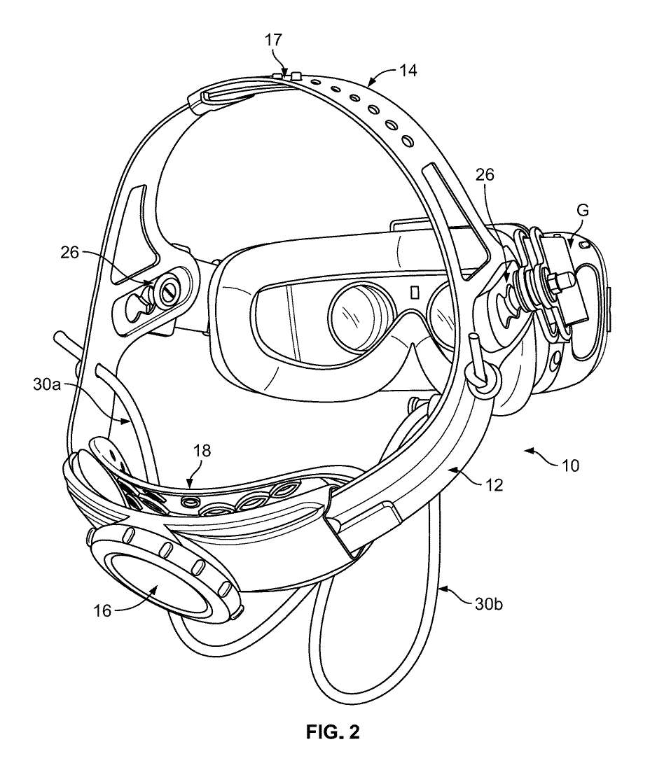

As can be seen in FIG. 1, for example, a headband 10 in accordance with an embodiment of the present disclosure preferably includes a rear element 12 that extends around a back of the user's head. A top element 14 extends upward from a side of the rear element 12 and over the user's head to connect to the other side of the rear element. That is, the top element 14 extends over the user's head and connects the two opposing sides of the rear element 12. In a preferred embodiment, the rear element 12 includes an adjustment element 16 used to adjust the size of the rear element to accommodate heads of different sizes. In a preferred embodiment, the adjustment element 16 is a rotatable knob as can be seen in FIG. 1, for example, however, any suitable adjustment element may be used. Rotating the knob 16 adjusts the size of the rear element 12 to accommodate heads of different sizes. Using the knob 16 is convenient since the user can adjust the size of the headband 10 using one hand while the headband 10 is in place on the user's head and thus the size can be easily customized for each individual user. In an embodiment, the rear element 12 includes a comfort panel 18 along the inner surface thereof in the area where the rear of the user's head contacts the rear element 12. This panel 18 allows for a snug and comfortable fit. The panel 18, however, need not be used. If desired, the top element 14 may include an adjustment mechanism 17 (see FIG. 2, for example) to change the size thereof and accommodate different head sizes.

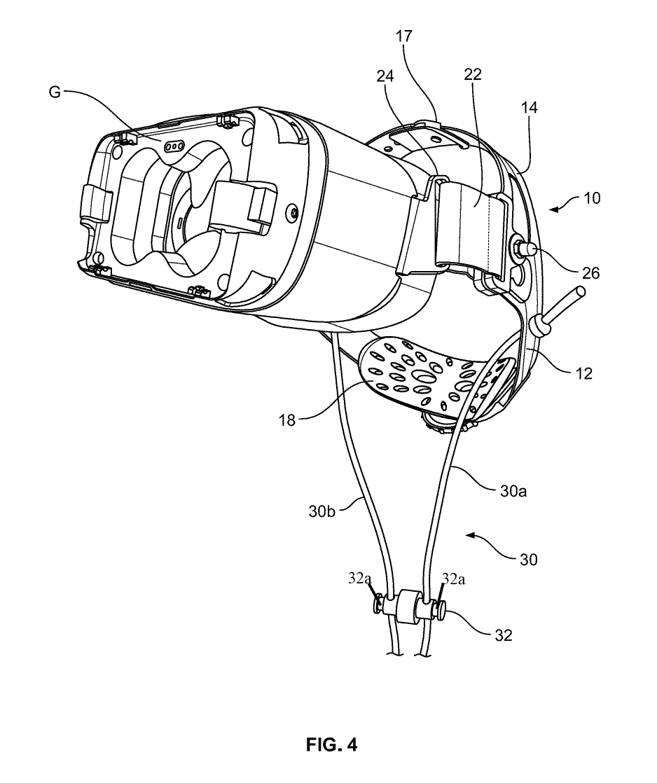

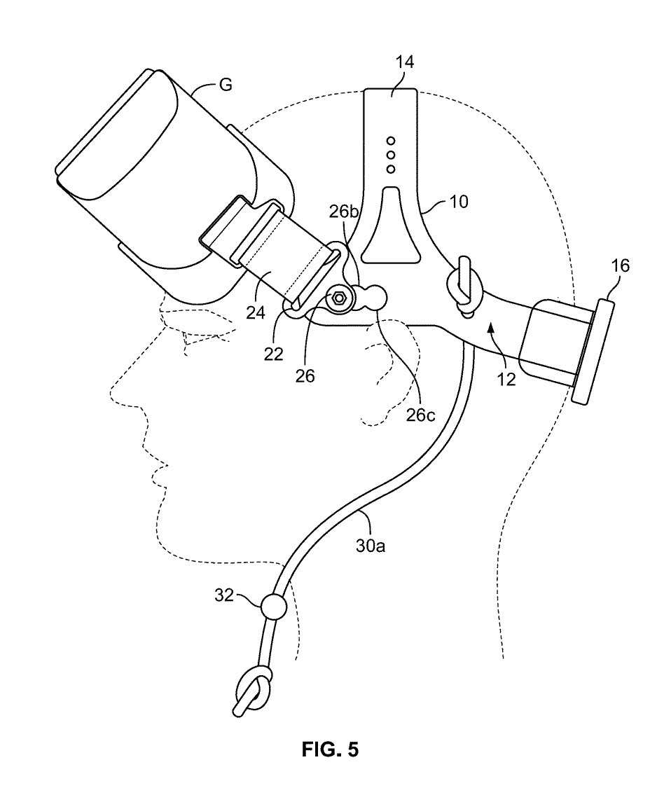

In a preferred embodiment, the rear element 12 and the top element 14 are preferably made of hard plastic such that the headband 10 is durable and easy to clean and sanitize. A goggle fastening element 20 is preferably provided on a front portion of each side of the rear element 12 and connects to the VR goggles G. In an embodiment, each goggle fastening element 20 includes a D-ring 22 that is pivotably secured to the front portion of the rear element 12. A resilient element 24, preferably an elastic band, connects the VR goggles G to the D-ring 22. In a preferred embodiment, the D-ring 22 is pivotably secured to the front portion of the rear element 12 via a pivot element 26. In FIG. 1, the pivot element 26 is a bolt; however, the pivot element is not limited to a bolt and any suitable pivot element maybe used including but not limited to a screw, screw and nut or screw, nut and washer combination, etc. FIG. 1 illustrates the bolt 26 passing through an opening in the front portion of the rear element 12 and illustrates additional openings 26b and 26c in the rear element that may also accommodate the pivot element 26. These additional openings 26b, 26c provide additional flexibility in sizing the headband 10. In addition, while FIG. 1 illustrates a D-ring 22, any suitable fastening element or bracket may be used to engage the resilient element 24. The pivoting element 26 allows the goggles G to move from an operable position in front of the user's eyes, as illustrated in FIG. 1, for example, to a second position, illustrated in FIG. 5, for example, where the goggles are raised above the user's eyes such that the user can take a break from the VR world without removing the headband 10. It is preferred that resilient element 24 be used to secure the goggles G to the D-ring 22 such that the goggles are held tightly to the user's face when in use, but can be pulled slightly away from the face of the user to allow for the pivoting discussed above without injuring or causing the user discomfort, however, the headband 10 need not include the resilient element and any other suitable connection between the D Ring and the goggle may be used. While FIGS. 1 and 3-7 show one side of the headband 10, the opposite side thereof has corresponding structure that operates in substantially the same way. The rear element 12 of the headband 10 preferably is substantially U-shaped such that it wraps around the head of the user from one side to the opposite side thereof.

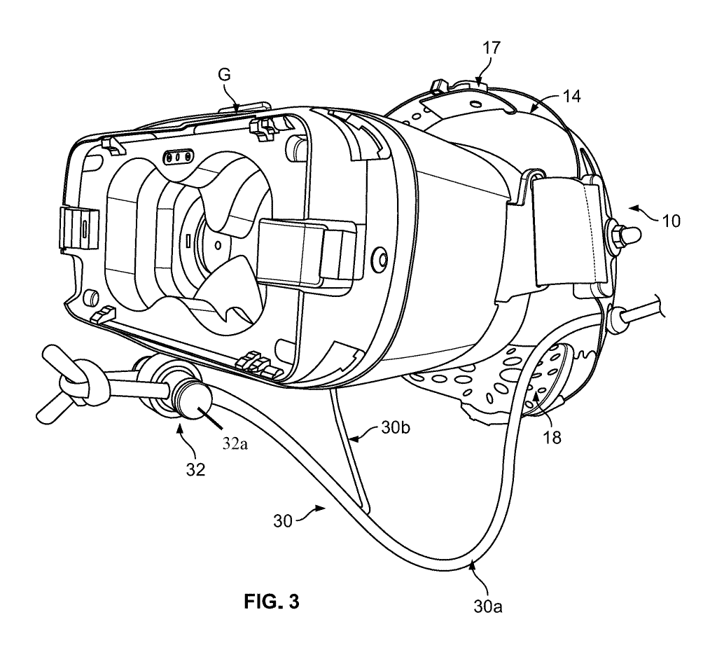

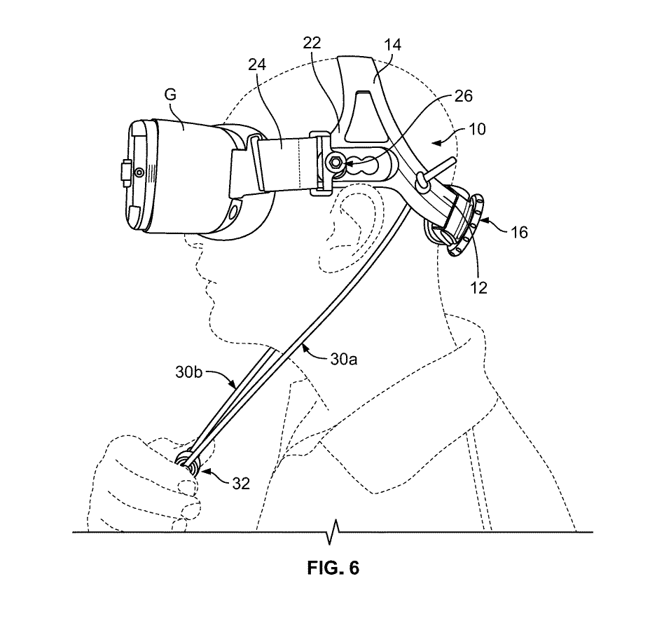

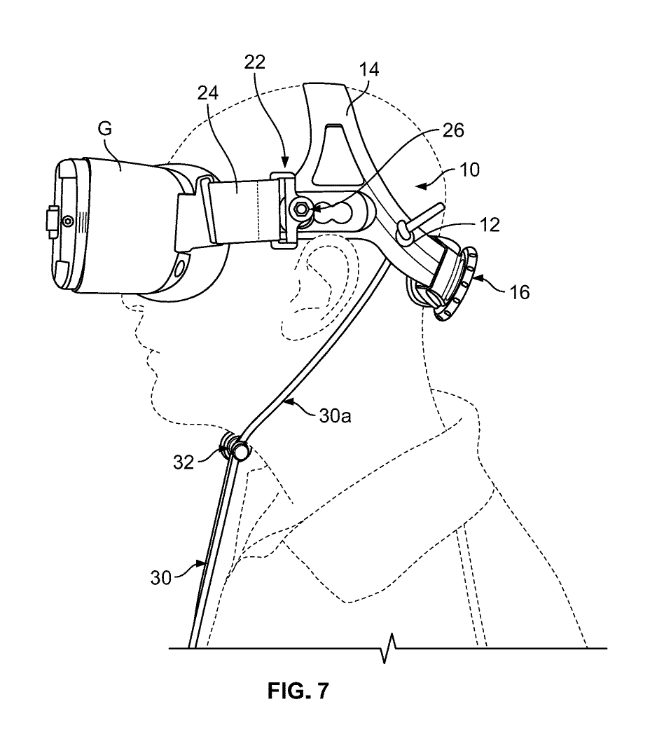

In a preferred embodiment, the headband 10 also includes a chin strap 30. In an embodiment, the chin strap 30 includes two flexible elements 30a, 30b (see FIGS. 2-4 and 6-7, for example), each of which is connected at one end thereof to the rear element 12, with one of the elements connected on each side of the rear element. A lock element 32 is provided on the opposite ends of the elements 30a, 30b, respectively. The lock element 32 is selectively movable along the length of the elements 30a, 30b to move the chin strap 30 between an open position in which the headband 10 is easily put on by the user, as illustrated in FIG. 6, for example, and a closed position, illustrated in FIG. 7, for example, in which the chin strap 30 holds the headband tightly to the user's head. The lock element 32 may be released by the user to allow movement of the lock element along the elements 30a, 30b to allow loosening of the chin strap 30 for removal or comfort, by activating a release trigger 32a, or triggers (See FIG. 3 or 6, for example). Any suitable release mechanism may be used. FIG. 6 illustrates a user engaging the lock element 32 to release it such that it is movable along the elements 30a, 30b of the chin strap 30. The lock element 32 is preferably biased in a locked state in which it will not move relative to the elements 30a, 30b such as it is illustrated in FIG. 7. As noted above, the ability to secure the headband 10 to the user's head securely using the chin strap 30 is important as it lowers the chances that the headband 10 and VR goggles G will become significantly misaligned with the user.

The headband 10 of the present application is preferably suitable for use with a wide variety of VR goggles. The headband 10 of the present application allows a user to comfortably wear and adjust VR goggles and can be easily adjusted in size to accommodate a wide variety of users. The headband 10 is made of a durable plastic and is securely fastened to the user's head for use.

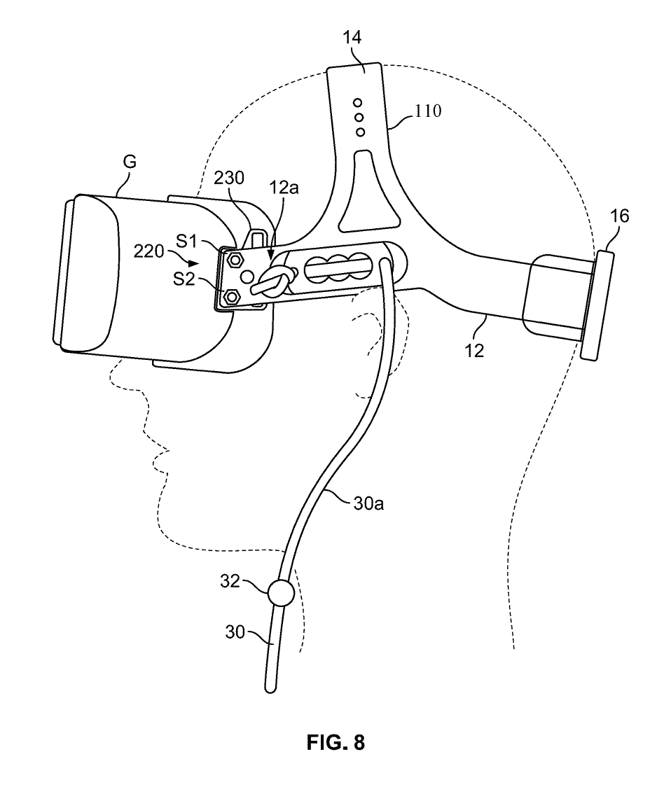

FIG. 8 illustrates another embodiment of a headband 110 suitable for use with a variety of VR goggles. The headband 110 is similar in structure to the headband 10 discussed above and the same reference numerals will be used to refer to common elements thereof. The headband 110 preferably includes a rear element 12 that extends around a back of the user's head and a top element 14 that extends upward from a side of the rear element 12 and over the user's head to connect to the rear element on the opposite side thereof. In a preferred embodiment, the rear element 12 includes adjustment element 16 used to adjust the length of the rear element to accommodate heads of different sizes. In a preferred embodiment, the adjustment element 16 is a rotatable knob as can be seen in FIG. 8, for example. Rotating the knob 16 adjusts the length of the rear element 12 to accommodate heads of different sizes. Using the knob 16 is convenient since the user can adjust the size of the headband 10 using one hand while the headband 10 is in place on the user's head. If desired, any other suitable adjustment element may be used. In an embodiment, the rear element 12 of the headband 110 includes comfort panel 18 along the inner surface thereof in the area where the rear of the user's head contacts the rear element 12 in substantially the same manner as in FIGS. 2-4, for example. This panel 18 allows for a snug and comfortable fit, however, is not necessary. If desired, the top element 14 may include an adjustment mechanism 17 to change the size thereof and accommodate different head sizes.

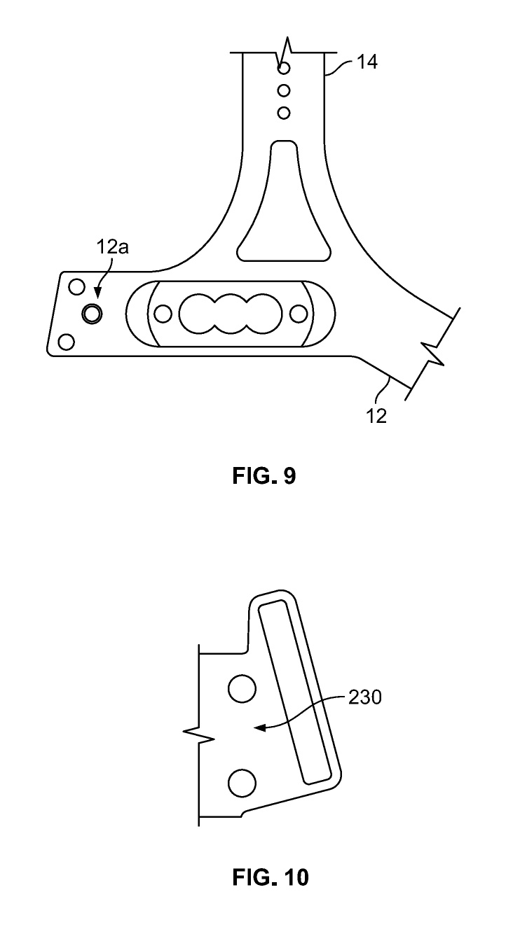

In a preferred embodiment, the rear element 12 and the top element 14 are made of hard plastic such that the headband 10 is durable and easy to clean and sanitize. A goggle fastening portion 12a of the rear element 12 extends forward on each side of the rear element and connects to the VR goggles G. In particular, as can be seen in FIG. 8, for example, the fastening portion 12a extends forward from the area where the top element 14 joins with the rear element 12. The fastening portion 12a preferably includes an attachment element 220 positioned at a front end thereof. This attachment element 220 connects to the goggles G. As illustrated in FIG. 8, the attachment element 220 includes two screws S1, S2 that pass through openings in the fastening portion 12a and the goggles G. While the attachment element 220 is illustrated as including screws S1, S2 in FIG. 8, any suitable attachment element may be used. The headband 110 also includes the chin strap 30 and the two elements 30a, 30b thereof as well as the lock element 32 discussed above. FIG. 9 is a more detailed view of the fastening portion 12a of the rear element 12. It is noted that the rear element 12 is not limited to the specific dimensions illustrated. FIG. 10 illustrates a more detailed view of attachment bracket 230 that is also secured to the goggles G and through which the screws S1, S2 pass. While FIGS. 8-10 show one side of the headband 10, the opposite side thereof has corresponding structure that operates in substantially the same way. The rear element 12 of the headband 10 preferably is substantially U-shaped such that it wraps around the head of the user from one side to the opposite side thereof to include two opposite fastening portions 12a on opposite ends of the U-shape. As illustrated, the headband 110 preferably includes a chin strap 30 and lock mechanism 32 substantially the same as that described above with reference to the headband 10.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A headband for VR goggles comprises:
a rear element extending from one side of a user's head to the opposite side thereof;
a top element extending from one side of the rear element to the opposite side of the rear element and extending over a top of the user's head;
an adjustment element connected to the rear element such that manipulation of the adjustment element adjusts a length of the rear element; and
a goggle fastening device pivotally connected to the rear element and connectable to the VR goggles such that the VR goggles are pivotable relative to the rear element.

2. The headband of claim 1, wherein the adjustment element is a rotatable knob and the length of the rear element is increased when the knob is turned in a first direction and decreased when the knob is turned in a second direction, opposite the first direction.

3. The headband of claim 1 further comprising a chin strap connected to opposite sides of the rear element and extending downward under a user's chin to secure the headband to the user's head.

4. The headband of claim 3, wherein the chin strap further comprises:
a first flexible element attached at a first end thereof to a first side of the rear element;
a second flexible element attached at a first side thereof to a second side of the rear element, the second side opposite the first side; and
a lock element connecting the first flexible element and the second flexible element and positioned under a chin of the user, the lock element selectively slidable along the first flexible element and the second flexible element toward and away from the chin of the user to allow for securing and releasing of the headband to the user's head.

5. The headband of claim 4, wherein the lock element is biased into a locked position in which it is prevented from sliding along the first flexible element and second flexible element.

6. The headband of claim 4, wherein the lock element further comprises a release trigger to selectively allow the lock element to slide up and down the first flexible element and the second flexible element.

7. The headband of claim 1, wherein the goggle fastening element further comprises:
a pair of brackets attached to opposite sides of the rear element, each bracket pivotally attached to the rear element;
a pair of connecting elements, each of which connect on one end to a respective bracket of the pair of brackets and connect on the other end to the VR goggles such that the VR goggles are pivotable relative to the rear element.

8. The headband of claim 7, wherein each connecting element of the pair of connecting elements is a resilient element biased to hold the VR goggle close to the user's face while allowing the VR goggles to be pulled away from a user's face before pivoting.

9. The headband of claim 1, further comprising an adjustment device connected to the top element such that a length of the top element is adjustable by operation of the adjustment device.

10. The headband of claim 1, wherein the rear element further comprises a plurality of openings formed in the opposite sides thereof such that the goggle fastening device is connectable to the rear element at different selective positions.

11. The headband of claim 1, further comprising comfort panel provided on the inner surface of the rear element.

12. A headband for VR goggles comprises:
a rear element extending from one side of a user's head to the opposite side thereof;
a top element extending over a top of the user's head from one side of the rear element to the opposite side of the rear element;
an adjustment element connected to the rear element such that manipulation of the adjustment element adjusts a length of the rear element; and
a goggle fastening device connected to the rear element and connectable to the VR goggles.

13. The headband of claim 12, wherein the adjustment element is a rotatable knob and the length of the rear element is increased when the knob is turned in a first direction and decreased when the knob is turned in a second direction, opposite the first direction.

14. The headband of claim 12 further comprising a chin strap connected to opposite sides of the rear element and extending downward under a user's chin to secure the headband to the user's head.

15. The headband of claim 14, wherein the chin strap further comprises:
a first flexible element attached at a first end thereof to a first side of the rear element;
a second flexible element attached at a first side thereof to a second side of the rear element, the second side opposite the first side; and
a lock element connecting the first flexible element and the second flexible element and positioned under a chine of the user, the lock element selectively slidable along the first flexible element and the second flexible element toward and away from the chin of the user to allow for securing and releasing the headband to the user's head.

16. The headband of claim 15, wherein the lock element is biased into a locked position in which it is prevented from sliding along the first flexible element and second flexible element.

17. The headband of claim 15, wherein the lock element further comprises a release trigger to selectively allow the lock element to slide up and down the first flexible element and the second flexible element.

18. The headband of claim 12, wherein the goggle fastening element further comprises:
two pairs of fasteners, each pair positioned on opposite sides of the rear element; and
a bracket connected to the VR goggle and including two pairs of openings formed on opposite sides thereof to receive the two pairs of fasteners, respectively, wherein each pair of fasteners passes through the rear element and the bracket to secure the VR goggles to the headband.

19. The headband of claim 12 further comprising an adjustment device connected to the top element such that a length of the top element is adjustable by operation of the adjustment device.

20. The headband of claim 12 further comprising a comfort panel provided on the inner surface of the rear element.
